(19) United States
(12) Patent Application Publication
(10) Pub. No.: US 2008/0169579 A1
(43) Pub. Date: Jul. 17, 2008

(54) Method and Apparatus for Depositing Large Textile Fiber Webs

(75) Inventors: Peter MUELLER-HUMMEL, Koetz (DE); Patrick TER, Augsburg (DE); Jochen SCHOLLER, Grossaitingen (DE); Franz STADLER, Boehmfeld (DE); Gerd BERCHTOLD, Weilheim (DE)

Correspondence Address: CROWELL & MORING LLP;INTELLECTUAL PROPERTY GROUP, P.O. BOX 14300, WASHINGTON, DC, 20044-4300, US

(73) Assignee: EADS Deutschland GmbH, Ottobrunn (DE)

(21) Appl. No.: 11/936,468

(22) Filed: Nov. 7, 2007

(30) Foreign Application Priority Data
Nov. 8, 2006 (DE) 102006052592.2

(51) Int. Cl. B29C 45/76

(52) U.S. Cl. 264/40.1

(57) ABSTRACT

In a process for depositing large dry textile fiber webs on a component shape, a rolled up textile fiber web is deposited fully automatically, by means of robots. A robot-carrier cloth gripper grips the end of the textile fiber web to be deposited, and places it on the component shape. The web is then unwound from the roll by a robot-carried cloth unwinding stand, and is deposited on the component shape. During the depositing, the textile fiber web is draped by means of robot-carried heated sliding metal sheets or robot-carried movably disposed heated rollers. The depositing operation is continuously monitored and automatically readjusted to maintain a constant depositing rate. Alignment of the textile fiber web relative to the component shape is also monitored continuously by optical devices, and is readjusted as required.

### BACKGROUND AND SUMMARY OF THE INVENTION

This application claims the priority of German patent document 10 2006 052 592.2, filed Nov. 8, 2006, the disclosure(s) of which is (are) expressly incorporated by reference herein.

The invention relates to a method and apparatus for depositing large textile fiber webs, particularly made of carbon fibers, for the manufacturing of fiber-reinforced plastic components (for example, CFCs, GFRPs, etc). Textile fiber webs of such a large size are those of a width of at least 500 mm.

An automatic depositing process for individual continuous fiber rovings is disclosed, for example, in German Patent Document DE 42 12 135 C2. In addition, mechanical depositing processes are also known for preimpregnated CFC strips, so-called tapes (U.S. Pat. No. 4,997,508). Since, as a result of their preimpregnation, these tapes are fixed immediately during their depositing, automatic processing can be carried out without difficulty. As a rule, the width of these tapes is only a few centimeters.

Heretofore, large textile fiber webs made of carbon fibers (for example, in the form of layings of a width of 1.27 m—corresponding to 50 inches—and of a length of up to 6 m), such as are used in airplane construction, could only be laid manually. However, manual depositing of such large laid webs can take place with only limited precision. Gaps occur between adjacent webs as well as waviness within a web.

German Patent Document DE 697 17 053 T2 describes a tape application head for producing sandwich-type plates by depositing textile fiber tapes. The end of the textile fiber tape, which is preimpregnated with resin and is to be deposited, is placed on a component shape. By displacing the tape application head, the textile fiber web is unwound from the roll and is deposited on the component shape. By means of a roller, the textile fiber web are draped simultaneously with the depositing.

European Patent Document EP 1 334 819 A1 describes a process for depositing preimpregnated fiber tapes, such that the alignment of the deposited tapes is continuously monitored by means of a camera. In addition, devices are provided by means of which the depositing operation is continuously monitored with respect to a predefined depositing rate.

European Patent Document EP 0 680 818 A2 describes a system for depositing preimpregnated, very thin fiber tapes. Movably disposed rolls are provided for the depositing of the fiber tape as well as for its compacting.

It is an object of the invention to provide a process for depositing large textile fiber webs, which achieves good quality of the manufactured fiber-reinforced plastic components, and which avoids fiber gaps, fiber waviness and fiber drawing, even in the case of complicated surface shapes.

This and other objects and advantages are achieved by the invention, which provides a fully automatic process for depositing large textile fiber webs, particularly made of carbon fibers, glass fibers or aramid fibers. In comparison to the manual process, the component quality is improved; in particular a fiber draft can largely be avoided and a good adaptation to the component shape can be achieved.

The textile fiber webs to be deposited are present in the form of dry materials; that is, they are not pre-impregnated by means of resin. They obtain their gluing properties, for example, by means of a thermoplastic binder nonwoven which is applied to the surface and melts under the effect of heat.

Dry textile fiber webs have the advantage that the individual fibers are fastened differently than in the case of pre-impregnated materials in that they remain movable within the fiber structure. By means of the draping operation, the textile fiber webs can therefore very easily be adapted to a curved component surface. In this case, the draping operation includes not only a compacting of the fiber material, but also a change of the fiber angles takes place within the fiber structure. The course of the fibers with respect to one another will change. As a result of this flexibility of the dry fiber material, it is possible to deposit large textile fiber webs of a width of 500 mm or more.

In order to achieve the adaptation to curved surfaces, according to the invention, high flexibility and mobility draping devices are used. In particular, these may be in the form of sliding metal sheets or movably disposed rolls.

In preferred embodiments, the textile fiber webs to be deposited have a surface of at least 3 m².

One textile fiber web may be present particularly as a laying (several rovings laid above one another and fixed, for example sewn together) or as a woven (individual fibers woven to one another). As a rule, the textile fiber webs have parallel edges, but the webs may be contoured arbitrarily (for example, having curved edges at least in sections).

Other objects, advantages and novel features of the present invention will become apparent from the following detailed description of the invention when considered in conjunction with the accompanying drawings.

### BRIEF DESCRIPTION OF THE DRAWINGS

FIG. 1 illustrates the gripping of a textile fiber web;

FIG. 2 shows the placement of the textile fiber web;

FIG. 3 is a view that shows the depositing of the textile fiber web;

FIG. 4 shows the depositing of the textile fiber web with an optical control of the web edge;

FIG. 5 shows the measurement of the diameter of the textile fiber roll for securing a uniform depositing;

FIG. 6 is a view of the continuous pull monitoring of the textile fiber web by means of a dancer roll;

FIG. 7 illustrates a first variant of draping of the textile fiber web;

FIG. 8 shows a second variant of the draping of the textile fiber web;

FIG. 9 is a view which shows the fixing of the textile fiber web during the gripping of the textile fiber web; and

FIG. 10 is a view of the cutting of a textile fiber web.

### DETAILED DESCRIPTION OF THE DRAWINGS

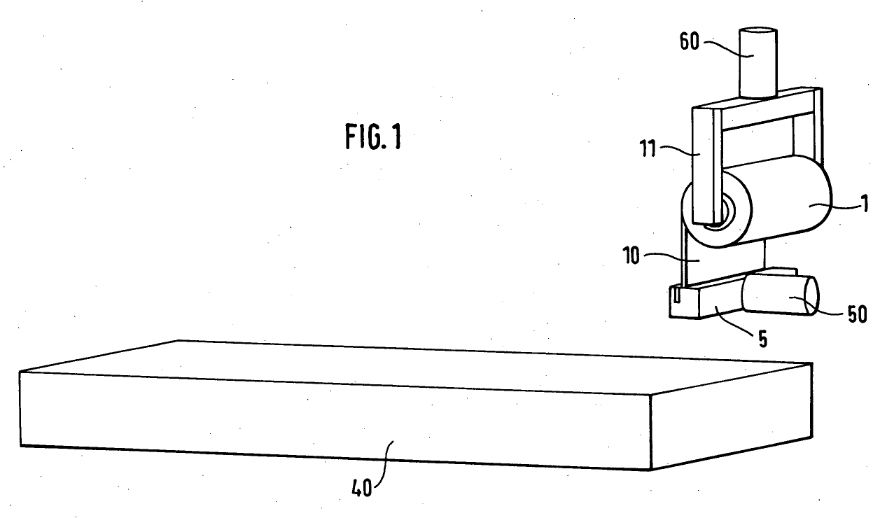

FIGS. 1 to 3 show the three principal steps of the process according to the invention, in an example of an essentially flat component surface. However, the process according to the invention is also and particularly suitable for a depositing on arbitrarily curved surfaces.

FIG. 1 illustrates a cloth gripper 5 gripping the dry textile fiber web 10, which is to be deposited, and which is rolled-up in a roll 1 on a driven roll axle. The roll axle is arranged on a cloth unwinding stand 11 which is carried by a first robot 60.

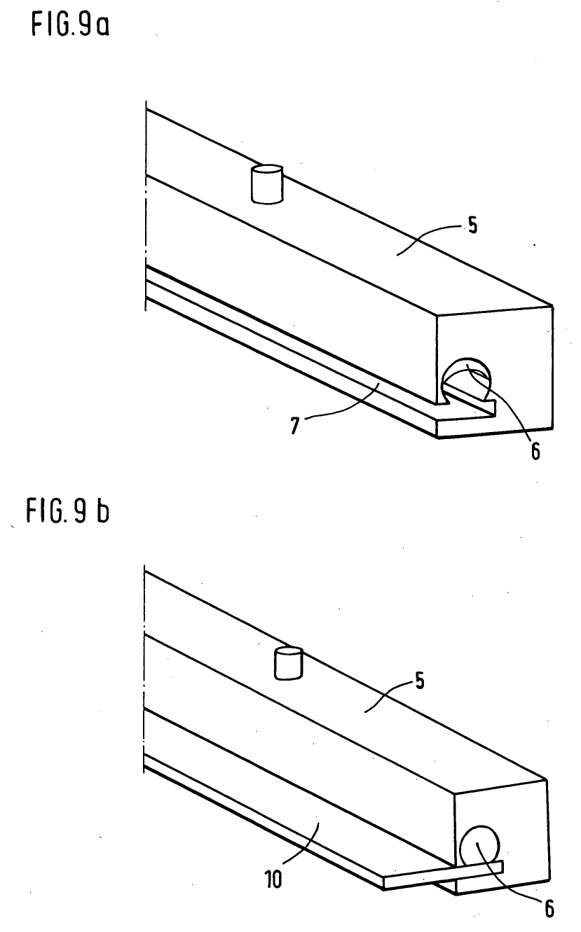

The cloth gripper 5 carried by a second robot 50 is moved into its position. The cloth unwinding stand 11 positions the edge of the textile fiber web 10 over a receiving slot 7 (FIG. 9) of the cloth gripper. The textile fiber web 10 is then unwound from the roll 1 to a defined length, and the cloth gripper 5 is then moved upward, so that the edge of the textile fiber web 10 arrives in the receiving slot 7 of the cloth gripper 5. Subsequently, the textile fiber web 10 is fixed in the cloth gripper by inflating a tube 6 (FIG. 9).

FIG. 9 illustrates the details of the cloth gripper 5, in two different operating phases. An elastic tube 6 is arranged adjacent the receiving slot 7 for the textile fiber web 10, and is connected with a vacuum pump. The tube 6 is shown evacuated in FIG. a) and inflated in FIG. b). It expands as a result of being inflated, so that the textile fiber web 10 situated in the receiving slot 7 is fixed.

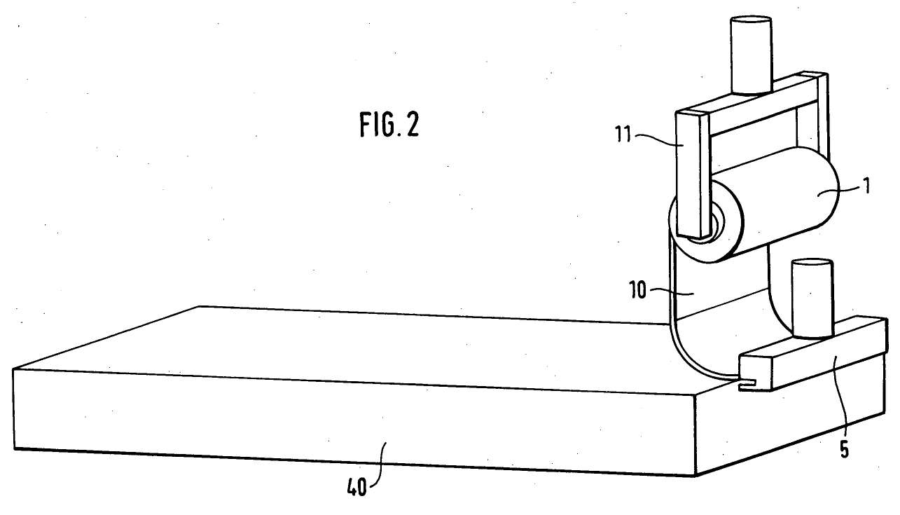

FIG. 2 shows the placement of the textile fiber web 10 on a component shape situated on the depositing table 40. The component shape, which is not shown for reasons of clarity, may have a flat surface. However, arbitrarily curved shapes (such as cylindrical, spherical shapes, etc.) are also possible. The textile fiber web 10 is wound off the roll 1 to a certain length. The cloth gripper 5 places the textile fiber web 10 in a defined position and correspondingly aligns the edges of the textile fiber web relative to the component shape. Before the cloth gripper 5 releases the textile fiber web again, a short section of it is deposited. After the releasing the textile fiber web, the cloth gripper 5 moves back into the basic position.

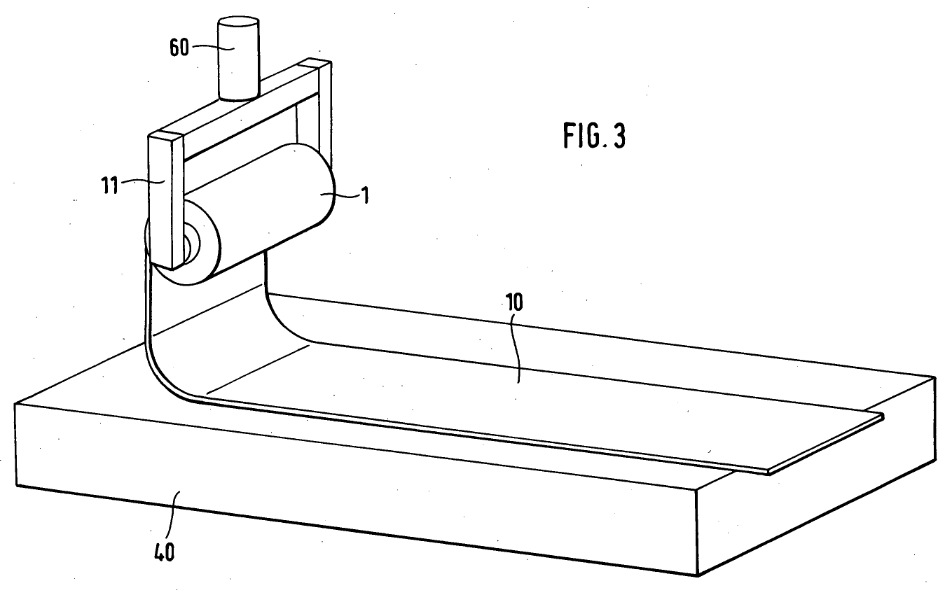

In a further process step, illustrated in FIG. 3, the textile fiber web 10 is deposited by means of a linear movement of either the cloth unwinding stand 11 or the depositing table 40, along a defined path.

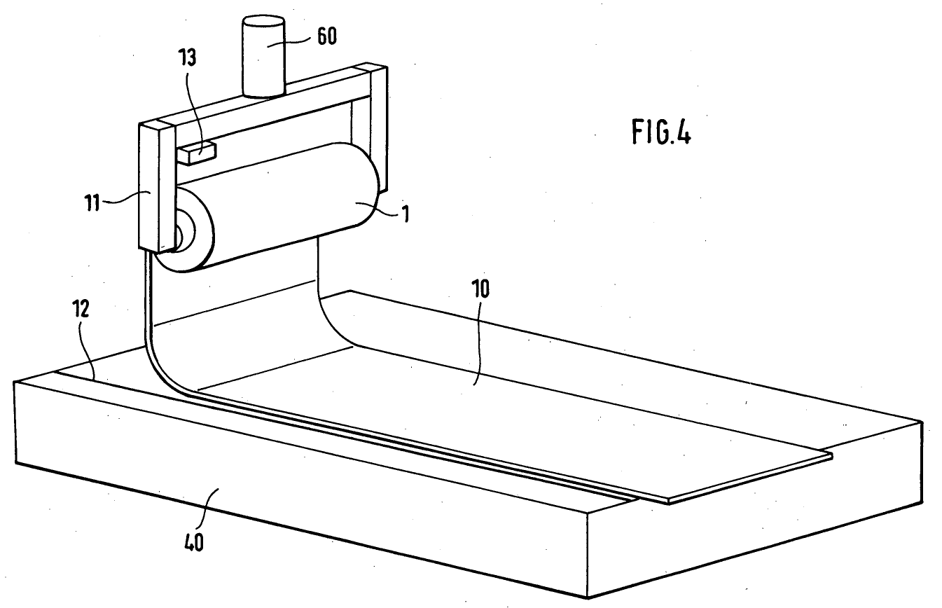

The path, along which the textile fiber web 10 is to be deposited, can be defined, for example, by means of an optical web edge control, shown in FIG. 4. The desired position defined corresponding to the component structure is marked by one or more laser lines 12 projected onto the shape. A sensor 13, for example, a so-called PSD chip, is situated on the cloth unwinding stand 11, and is coupled with the control of the robot 60. The chip 13 compares the position of a projected laser line with a desired position, and the robot control correspondingly corrects the position of the cloth unwinding stand 11 until the two positions coincide.

FIGS. 1 to 4 show the depositing of an individual textile fiber web in the 0° direction. After the cutting of the textile fiber web, additional textile fiber webs can be successively deposited on one another according to the same approach. Other depositing directions are also possible, particularly in the 90° direction and the ±45° direction.

During depositing, it must be ensured that the textile fiber web 10 can be deposited in a uniform manner, and thus at a constant depositing rate (deposited textile fiber surface per time unit). Tensions in the fiber material as well as wave formations in the deposited textile fiber web are to be avoided. For this purpose, the linear movement of the table 40 or of the cloth unwinding stand 11 and the rotating movement of the roll 1 must be mutually coordinated. Continuous control is therefore necessary because, unwinding of the textile fiber web from the roll changes its diameter continuously.

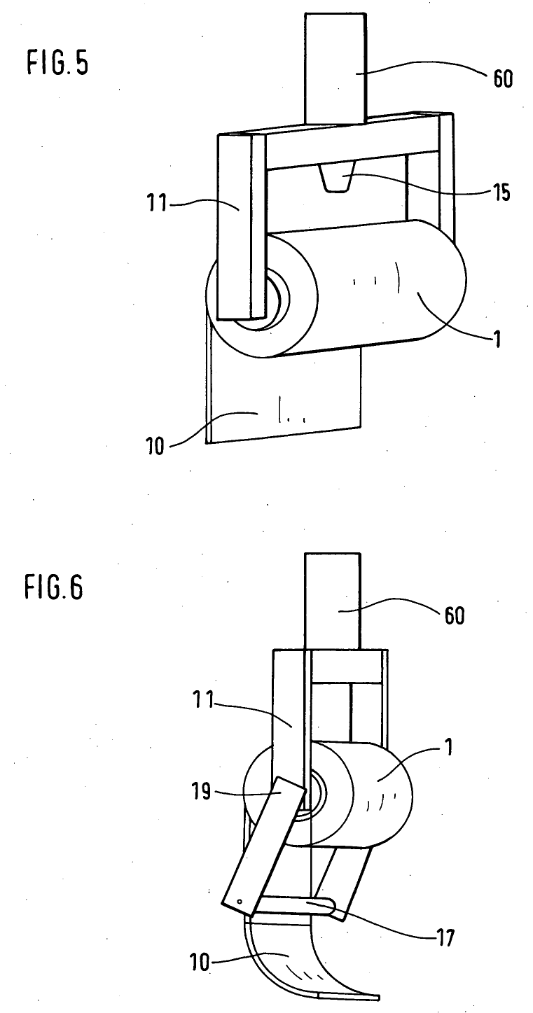

One way of ensuring a uniform depositing is to determine continuously the diameter of the roll 1. As illustrated in FIG. 5, this can be done, for example, in a no-contact manner by means of an optical sensor 15. (FIG. 5.) The rotational speed of the motor driving the roll 1 can be computed, as is required for a uniform depositing, by using the known thickness of the textile fiber web 10 and the linear speed of the cloth unwinding stand 11 or of the depositing table 40.

Another possibility for automatically adjusting a uniform depositing is the use of the so-called dancer roll 17, as illustrated in FIG. 6. The dancer roll is a swiveling deflection pulley over which the textile fiber web 10 runs during the depositing operation 10. The deflection of the dancer roll 17 about the axis 19 at the cloth unwinding stand 11 is a function of the tension in the textile fiber web 10. The deflection can be converted to electrical voltage by means of a potentiometer. The rotational speed of the motor for driving the roll 1 is regulated as a function of the deflection of the dancer roll 17. In this case, a certain basic rotational speed is defined.

Another possibility for automatically adjusting a uniform depositing, which is not shown in the figures, can be achieved by using a light barrier. By way of a difference in brightness, the latter determines the relative position of that section of the textile fiber web that is momentarily situated between the roll and the depositing table to be a desired value. A regulator circuit correspondingly regulates the rotational speed of the motor.

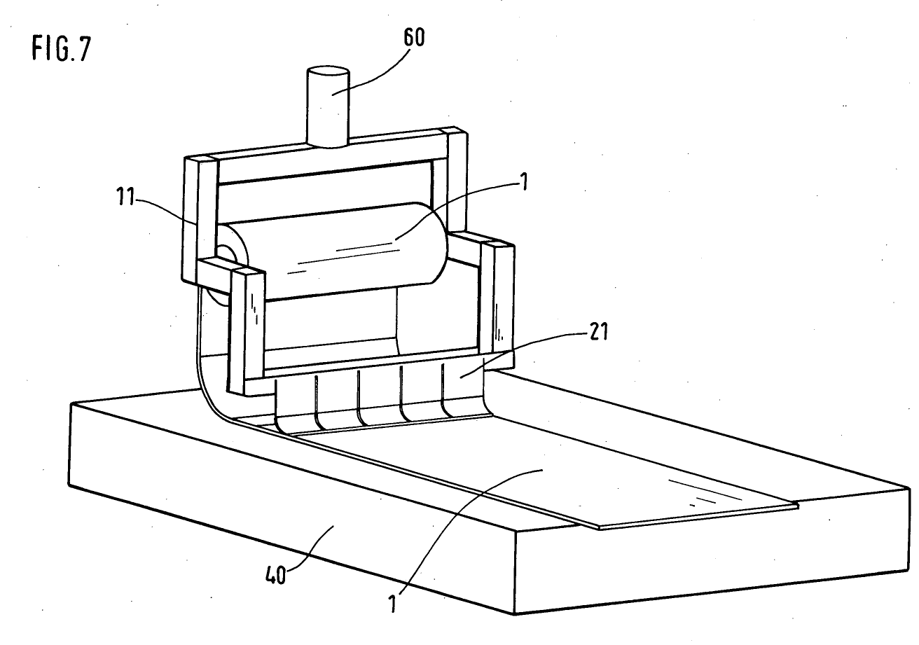

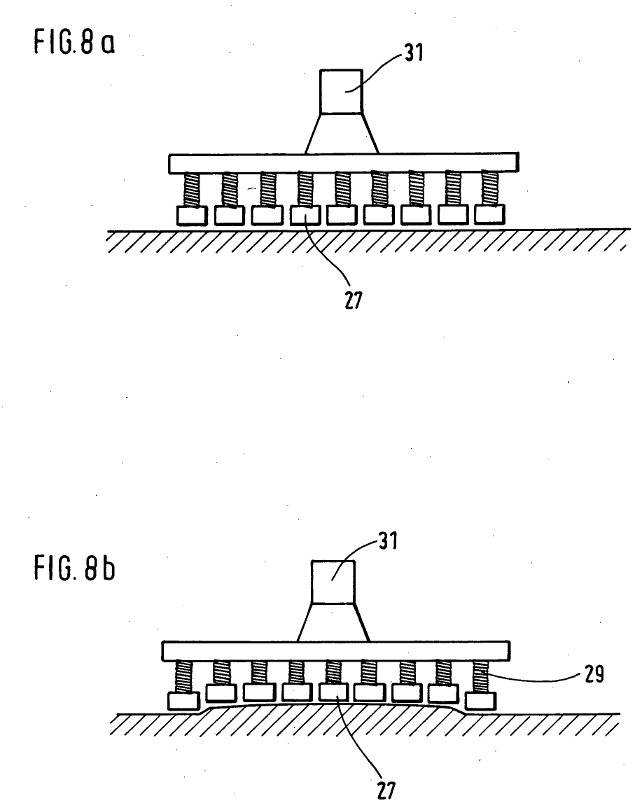

In the process according to the invention the applied textile fiber web is draped and fixed isochronously with the depositing, as is illustrated in two different embodiments contained in FIGS. 7 and 8. (FIG. 8 is a highly schematic representation.)

In FIG. 7, several surface-type sliding elements 21, such as sliding metal sheets, which are heated and are mounted on the cloth unwinding stand 11, move over the just deposited textile fiber material during the movement of the cloth unwinding stand 11 in the depositing operation. A binder nonwoven, which is deposited together with the textile fiber web 10, is applied to the textile fiber web 10. As a result of the entry of heat, the binder nonwoven glues the individual textile fiber webs to one another which are deposited above one another. Furthermore, as a result of the pressing onto the textile fiber web, the latter is compacted and, when the surfaces are curved, is adapted to these surfaces. The width of a sliding metal sheet may be varied as a function of the complexity of the surface shape of the component.

According to the embodiment of FIG. 8, heatable rolls 27 are used for the draping. FIG. 8a) shows the use of the rolls 27 in the case of an essentially flat component contour, while FIG. b) shows the case of a curved component contour. Here, it is necessary that the rolls are disposed in a flexible manner, for example, by means of spring elements 29. A corresponding situation applies to the sliding elements 21 according to FIG. 7. Reference number 31 indicates the mechanical connection to the cloth unwinding stand 11. For the adaptation to the curved component surface, a change of the fiber angles takes place within the fiber structure by means of the draping operation.

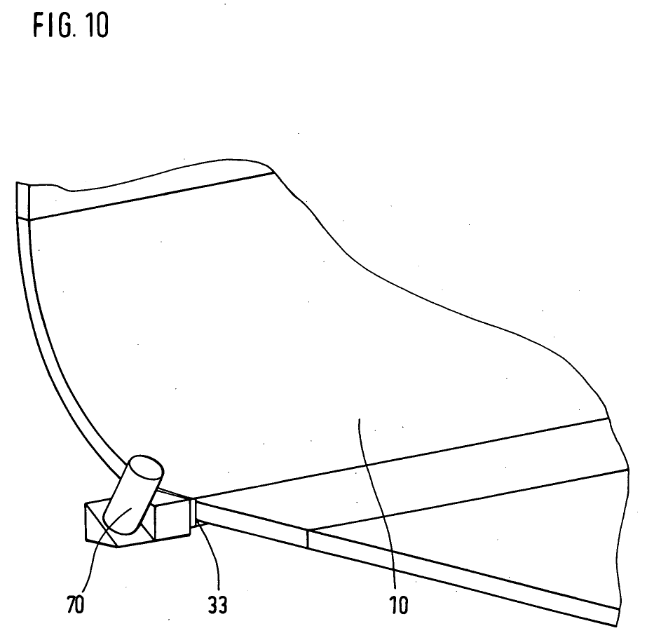

The cutting off of the textile fiber web 10 takes place along the component contour at the end of the deposited web, as illustrated in FIG. 10. A driven cutter 33 can be used for this purpose. The cutting direction is preferably parallel to the axis of the roll 1. The cutter 33 is carried by a separate robot 70. As an alternative, it may also be arranged at the cloth unwinding stand 11.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A process for automatically depositing textile fiber webs on a component shape for producing fiber-reinforced plastic components, the textile fiber web being present in the form of a roll, said process comprising:
a robot-carried cloth gripper gripping an end of the textile fiber web that is to be deposited, and placing it on the component shape;
a robot-carried cloth unwinding stand unwinding the textile fiber web from the roll and depositing it on the component shape;
during said depositing, draping the textile fiber web by one of robot-carried heated sliding metal sheets and robot-carried movably disposed heated rollers;
continuously monitoring the depositing operation and automatically readjusting a depositing rate to maintain it at a constant value; and
optical devices continuously aligning and readjusting positioning of the textile fiber web relative to the component shape to maintain such alignment;
wherein the textile fiber webs comprise dry textile fiber webs.

2. The process according to claim 1, wherein, to maintain a constant depositing rate the textile fiber web to be deposited is continuously monitored with respect to the pull.

3. The process according to claim 2, wherein the continuous pull monitoring of the textile fiber web is carried out by means of a dancer roll.

4. The process according to claim 1, wherein a constant depositing rate is maintained by continuously measuring the diameter of the roll.

5. The process according to claim 1, wherein a constant depositing rate is maintained by measuring the position of the section of the textile fiber web momentarily unwound from the roll relative to a desired value, by means of a light barrier.

6. The process according to claim 1, wherein, when a depositing end position is reached, a robot-carried cutter cuts the deposited textile fiber web off the roll.

7. The process according to claim 1, wherein the textile fiber web is continuously aligned by projecting an optical desired tape edge, which is detected by a roll-side optical sensor onto the component shape.

8. The process according to claim 1, wherein the textile fiber web is fixed on the cloth gripper by the expansion of an inflatable elastic element.

9. A process for manufacturing fiber-reinforced plastic components, said process comprising:
providing a dry textile fiber web with a thermoplastic binder nonwoven applied to its surface;
a robot-carried cloth gripper gripping an end of the textile fiber web that is to be deposited, and placing it on a desired component shape;
a robot-carried cloth unwinding stand unwinding the textile fiber web from the roll and depositing it on the component shape;
during said depositing, draping the textile fiber web by one of robot-carried heated sliding metal sheets and robot-carried movably disposed heated rollers;
continuously monitoring the depositing operation and automatically readjusting a depositing rate to maintain it at a constant value; and
optical devices continuously aligning and readjusting positioning of the textile fiber web relative to the component shape to maintain such alignment.

10. The process according to claim 9, wherein, to maintain a constant depositing rate the textile fiber web to be deposited is continuously monitored with respect to the pull.

11. The process according to claim 9, wherein the continuous pull monitoring of the textile fiber web is carried out by means of a dancer roll.

12. The process according to claim 9, wherein a constant depositing rate is maintained by continuously measuring the diameter of the roll.

13. The process according to claim 9, wherein a constant depositing rate is maintained by measuring the position of the section of the textile fiber web momentarily unwound from the roll relative to a desired value, by means of a light barrier.

14. The process according to claim 9, wherein, when a depositing end position is reached, a robot-carried cutter cuts the deposited textile fiber web off the roll.

15. The process according to claim 9, wherein the textile fiber web is continuously aligned by projecting an optical desired tape edge, which is detected by a roll-side optical sensor onto the component shape.

16. The process according to claim 9, wherein the textile fiber web is fixed on the cloth gripper by the expansion of an inflatable elastic element.
